(19) United States
(12) Patent Application Publication
(10) Pub. No.: US 2012/0169688 A1
(43) Pub. Date: Jul. 5, 2012

(54) 3D DISPLAY AND DRIVING METHOD THEREOF

(75) Inventors: Yu-Da Chen, Changhua County (TW); Chun-Huai Li, Hsinchu County (TW)

(73) Assignee: AU OPTRONICS CORPORATION, Hsinchu (TW)

(21) Appl. No.: 13/095,907

(22) Filed: Apr. 28, 2011

(30) Foreign Application Priority Data
Dec. 31, 2010 (TW) 99147248

(51) Int. Cl. G06F 3/038; G02B 27/22

(52) U.S. Cl. 345/209; 359/463

(57) ABSTRACT

A three-dimensional (3D) display including a display panel and a micro lens array is provided. The display panel includes a plurality of scan lines, a plurality of data lines, and a sub-pixel array. The sub-pixel array includes a plurality of sub-pixels arranged in an array. The sub-pixels arranged in any row are electrically connected to the same scan line. Each two sub-pixels in any column are electrically connected to an adjacent data line on a different side alternately. Polarity distribution of the sub-pixels is cyclically repeated in a row direction by one sub-pixel, and polarity distribution of the sub-pixels is cyclically repeated in a column direction by two sub-pixels. The micro lens array includes a plurality of lens units. An image displayed by the display panel produces a left-eye image and a right-eye image after passing through the micro lens array. Furthermore, a driving method is also provided.

### CROSS-REFERENCE TO RELATED APPLICATION

This application claims the priority benefit of Taiwan application serial no. 99147248, filed Dec. 31, 2010. The entirety of the above-mentioned patent application is hereby incorporated by reference herein and made a part of this specification.

### BACKGROUND OF THE INVENTION

1. Field of the Invention

The present invention generally relates to a display and a driving method thereof, in particular, to a three-dimensional (3D) display and a driving method applied to the 3D display.

2. Description of Related Art

In recent years, with the continuously advancement of display technology, the demands of the user for the display quality (such as image resolution and color saturation) of the displays become increasingly higher. However, besides high image resolution and high color saturation, in order to meet the demands of the user for viewing real images, displays for displaying 3D images have been developed.

Generally, 3D imaging technology is classified into three types, that is, a holographic type, a multi-planner type, and a parallax images type. As the holographic type and multi-planner type 3D imaging technologies have the disadvantages of being difficult to process a large amount of data and having a poor display effect, parallax images type 3D imaging technology becomes the main stream in recent years. The parallax images type display adopts spatial-multiplexed 3D display technology as the main application technology. The spatial-multiplexed 3D display technology enables a displayed frame to form a left-eye visible area and a right-eye visible area by using a micro lens array (lenticular screen) or a parallax barrier, so as to achieve the 3D effect.

Compared with column inversion driving and row inversion driving, dot inversion driving is widely adopted, because it enables the display to have a good display quality. FIG. 1 is a schematic view of a polarity of a 3D display panel displaying in a dot inversion driving manner in the related art. Referring to FIG. 1, polarity distribution of an image displayed by sub-pixels in the 3D display 100 is dot inversion as shown in FIG. 1, and the image displayed by the sub-pixels is divided into a left-eye image I_{L} and a right-eye image I_{R} in a row direction through a micro lens array. Specifically, as shown in FIG. 1, when a column of sub-pixels at the rightmost side is a first column of sub-pixels, the patterns displayed by the sub-pixels in the odd-number columns form the left-eye image I_{L}, and the patterns displayed by the sub-pixels in the even-number columns form the right-eye image I_{R}. As shown in FIG. 1, the polarity distribution of the left-eye image I_{L} and the polarity distribution of the right-eye image I_{R} produced by the image after passing through the micro lens array are respectively in a manner of row inversion, and the polarity of the left-eye image I_{L} is just opposite to the polarity of the right-eye image I_{R} at the same position of the formed 3D image, for example, in FIG. 1, the polarity of each row of the left-eye image I_{L} is positive, negative, positive, and negative from top to bottom columns respectively, and correspondingly, the polarity of each row of the right-eye image I_{R} is negative, positive, negative, and positive from top to bottom columns. Taking the polarity of the topmost row as an example, the topmost row of the left-eye image I_{L} has the positive polarity, and the topmost row of the right-eye image I_{R} has the negative polarity. Therefore, when the user views the image displayed by the 3D display, as the polarity of the left-eye image I_{L} and the polarity of the right-eye image I_{R} at the left eye and the right eye are different from each other, a problem of flicker of the images viewed by the left eye and the right eye occurs, which results from the images viewed by the left eye and the right eye are both displayed by row invention, and thus influences the display quality of the 3D display.

Additionally, the polarity of the data signal transmitted in each data line on the panel will be switched between the positive and negative polarity in the same frame in the dot inversion driving manner, such that the driving circuit becomes complex, and thus resulting in the disadvantages of high power consumption and high cost.

### SUMMARY OF THE INVENTION

Accordingly, the present invention is directed to a 3D display, capable of solving a problem of flicker.

The present invention is further directed to a driving method of a 3D display, capable of enabling the 3D display to have a good display quality at low power consumption.

The present invention provides a 3D display, which includes a display panel and a micro lens array. The display panel includes a plurality of scan lines, a plurality of data lines, and a sub-pixel array. The scan lines intersect the data lines. The sub-pixel array includes a plurality of sub-pixels arranged in an array. The sub-pixels in any row are electrically connected to the same scan line. Each two sub-pixels in any column are electrically connected to an adjacent data line on a different side alternately. Polarity distribution of the sub-pixels is cyclically repeated in a row direction by one sub-pixel, and polarity distribution of the sub-pixels is cyclically repeated in a column direction by two sub-pixels. The micro lens array includes a plurality of lens units. An image displayed by the display panel produces a left-eye image and a right-eye image after passing through the micro lens array.

In an embodiment of the present invention, the sub-pixel includes a plurality of left-eye sub-pixels for displaying the left-eye image and a plurality of right-eye sub-pixels for displaying the right-eye image. Specifically, the left-eye sub-pixels are, for example, arranged in odd-number rows, and the right-eye sub-pixels are, for example, arranged in even-number rows. Furthermore, any one of the lens units is, for example, corresponding to at least one of the left-eye sub-pixels and at least one of the right-eye sub-pixels simultaneously, and among the sub-pixels in the same column, the left-eye sub-pixel and the right-eye sub-pixel corresponding to the same lens unit are, for example, electrically connected to the same data line.

In an embodiment of the present invention, each lens unit extends, for example, in the row direction, each sub-pixel includes a pixel pitch d parallel to the column direction, and each lens unit includes a lens pitch D parallel to the column direction, in which the lens pitch D of each lens unit substantially satisfies the following relation formula: D=2×d.

In an embodiment of the present invention, the sub-pixels arranged in a (4n+1)^{th} row and a (4n+2)^{th} row are electrically connected to an adjacent data line on a left side thereof, and the sub-pixels arranged in a (4n+3)^{th} row and a (4n+4)^{th} row are electrically connected to an adjacent data line on a right side thereof, in which n is a positive integer.

In an embodiment of the present invention, the sub-pixels include a plurality of first primary color sub-pixels arranged in the same column, a plurality of second primary color sub-pixels arranged in the same column, and a plurality of third primary color sub-pixels arranged in the same column, in which the first primary color sub-pixels, the second primary color sub-pixels, and the third primary color sub-pixels of each row are alternately arranged in sequence. Specifically, among the sub-pixels in the same row, the adjacent first primary color sub-pixel, second primary color sub-pixel, and third primary color sub-pixel form, for example, one pixel unit.

In an embodiment of the present invention, in the same frame time, a polarity of a data voltage respectively transmitted by each data line remains unchanged.

In an embodiment of the present invention, the sub-pixel array may further include a plurality of dummy sub-pixels, configured on at least one side, for example, two sides, of the sub-pixels, and electrically connected to at least one data line on an outermost side.

The present invention further provides a driving method of a 3D display, for example, applied to drive the 3D display described above. The driving method of the 3D display includes the following steps. The scan lines are turned on sequentially. Next, in the same frame time, a first polarity signal is input to odd-number data lines, and a second polarity signal is input to even-number data lines.

In an embodiment of the present invention, the driving method of the 3D display further includes that in a next frame time, the second polarity signal is input to the odd-number data lines, and the first polarity signal is input to the even-number data lines.

In an embodiment of the present invention, in the driving method of the 3D display, for example, an inverse polarity signal is input to the odd-number data lines, and an anti-inverse polarity signal is input to the even-number data lines, such that display of the sub-pixel array is shown in a manner of two dot inversion.

In view of the above, each two sub-pixels in any column in the 3D display of the present invention are electrically connected to an adjacent data line on a different side alternately, and through the layout, the data lines are enabled to drive a sub-pixel array in a low power consumption driving manner, so as to achieve a display effect of two line two dot inversion, thereby reducing the power consumption of the data lines, and thus achieving the function of power saving. Furthermore, as the display effect of the left-eye image and the right-eye image is shown in the dot inversion, the problem of pixel flicker of the 3D image is eliminated. Thus, vertigo and discomfort caused by the inversion of the left-eye signal and the right-eye signal is eliminated significantly.

In order to make the aforementioned features and advantages of the present invention more comprehensible, embodiments are described in detail below with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a polarity of a 3D display panel displaying in a dot inversion driving manner in the related art.

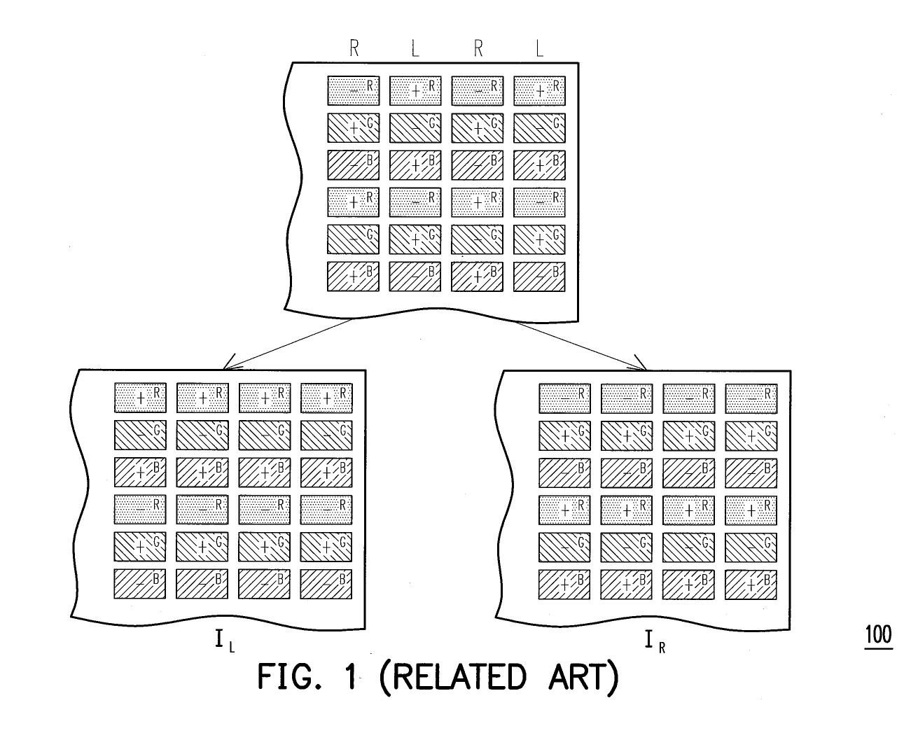

FIG. 2 is a schematic view of a 3D display according to an embodiment of the present invention.

FIG. 3 is a schematic enlarged view of FIG. 2 captured at a site A.

FIG. 4 shows a schematic view of a state of a display panel in the 3D display in FIG. 2 under a driving method at an upper part and a schematic view of a signal state of the display panel in the 3D display in FIG. 2 in a frame time at a lower part.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

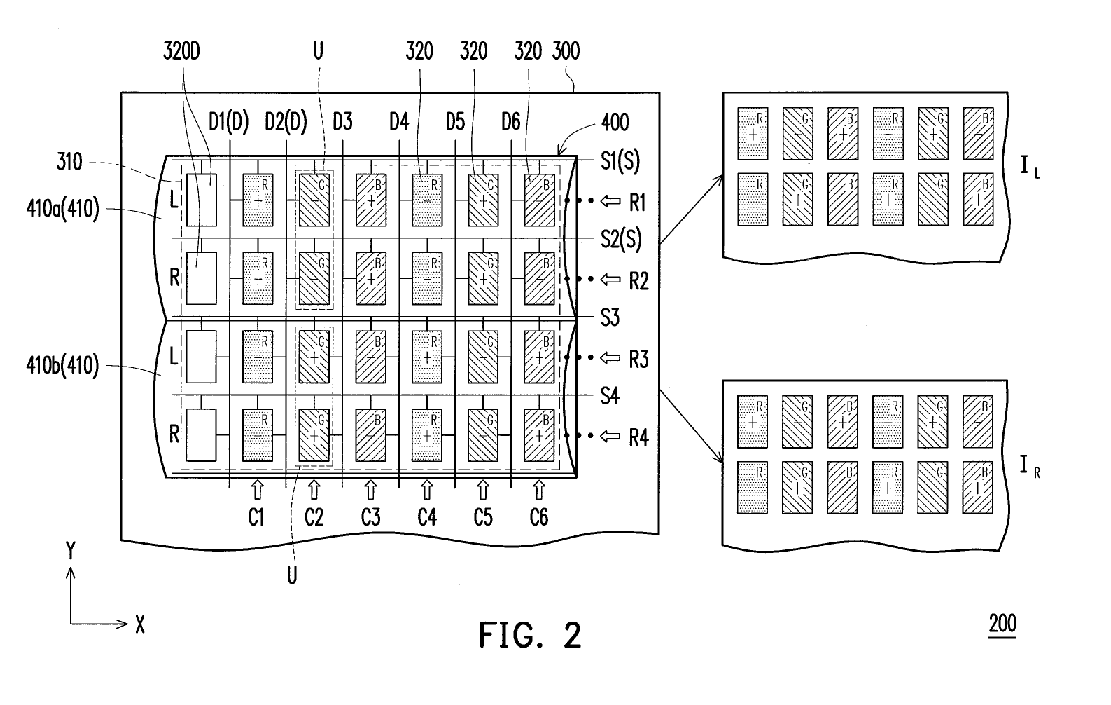

FIG. 2 is a schematic partial enlarged view of a 3D display according to an embodiment of the present invention. Referring to FIG. 2, the 3D display 200 includes a display panel 300 and a micro lens array 400. The display panel 300 may be a flat display panel, for example, a liquid crystal display (LCD) panel, an organic electroluminescent display panel, a plasma display panel, an electrophoretic display panel, or other suitable display panels, and the display panels are well known to persons skilled in the art, and will not be repeated herein. The micro lens array 400 is located in front of the display panel 300, and is used for projecting an image displayed by the display panel 300 to a left eye and a right eye of a user respectively, such that the user can observe a 3D image. Specifically, the display panel 300 includes a plurality of scan lines S, a plurality of data lines D, and a sub-pixel array 310. In this embodiment, each scan line S extends in a row direction X, and includes scan lines S1, S2, S3, and S4 sequentially from top to bottom respectively. Each data line D extends in a column direction Y, and includes data lines D1, D2-D6 sequentially from left to right respectively. The scan lines S intersect the data lines D to define a plurality of sub-pixels 320 arranged in an array, so as to form the sub-pixel array 310.

It should be noted that, in an embodiment of the present invention, a direction parallel to the scan lines S is the row direction X, a direction parallel to the data lines D is the column direction Y, and positions of other means are described with respect to the row direction X and the column direction Y. However, the position of each means in the 3D display 200 of the present invention is not limited to an absolute position relation of the column direction Y and the row direction X in the embodiment, and persons of ordinary skill in the art may select a placement angle of the 3D display 200 appropriately with reference to the description of the present invention. Therefore, as long as each means in the 3D display 200 satisfies the relative relation described in the present invention, the 3D display 200 will fall in the protection scope of the present invention, and the present invention is not limited to the aspects disclosed in the following embodiments.

Referring to FIG. 2, the sub-pixel array 310 includes a plurality of sub-pixels arranged in an array 320 and electrically connected to corresponding scan lines S and data lines D. In this embodiment, the sub-pixel array 310 may further include a plurality of dummy sub-pixels 320D, configured on at least one side of the sub-pixels 320, and electrically connected to at least one data line D on an outermost side. For example, the dummy sub-pixel 320D of this embodiment is located in a leftmost column in FIG. 2, and is electrically connected to the data line D1. Definitely, in other embodiments, one data line (not shown) can be disposed on the left side of dummy sub-pixel 320D of the column, and is electrically connected to other dummy sub-pixels 320D of the column. Alternatively, in other embodiments, another column of dummy sub-pixels 320D (not shown) can be disposed at the rightmost column of the sub-pixel array 310, and electrically connected to the corresponding data lines D, but the present invention is not limited to the number and the position of the disposed dummy sub-pixels 320D and the manner in which the dummy sub-pixels 320D are electrically connected to the data lines D.

The sub-pixels 320 in any row are electrically connected to the same scan line S, for example, the sub-pixels 320 in the row R1 are electrically connected to the same scan line S1. Particularly, each two sub-pixels 320 in any column are electrically connected to an adjacent data line D on a different side alternately. Furthermore, a polarity of each two sub-pixels 320 for which the data signals are written through the same data line D are arranged in a zigzag manner. It should be noted that, a symbol “+” and a symbol “−” in the figures indicate the relative polarity of the data signal on the side. For example, the symbol “+” and the symbol “−” indicate the positive polarity and the negative polarity respectively, and are used for determining the positive polarity and the negative polarity of the sub-pixel 320 after the data signal is written.

For example, among the sub-pixels 320 in the C2 column, the sub-pixels 320 are electrically connected to an adjacent data line D2 on the left side and an adjacent data line D3 on the right side by two sub-pixels as a unit U alternately. Furthermore, in this embodiment, the data line D1, the data line D2, the data line D3 respectively transmit a data signal “+” of the positive polarity, a data signal “−” of the negative polarity, and a data signal “+” of the positive polarity in the frame time. Therefore,) among the sub-pixels 320 in the C2 column, the sub-pixels 320 arranged in a (4n+1)^{th} row and a (4n+2)^{th} row are electrically connected to the adjacent data line D2 on the left side thereof respectively, and have a negative polarity “−”, and the sub-pixels 320 arranged in a (4n+3)^{th} row and a (4n+4)^{th} row are electrically connected to the adjacent data line D3 on the right side thereof respectively, and have a positive polarity “+”, in which n is a positive integer. Similarly, among the sub-pixels 320 arranged in the C1 column, the sub-pixels 320 arranged in the (4n+1)^{th} row and the (4n+2)^{th} row are electrically connected to the adjacent data line D1 on the left side thereof respectively, and have a positive polarity “+”, and the sub-pixels 320 arranged in the (4n+3)^{th} row and the (4n+4)^{th} row are electrically connected to the adjacent data line D2 on the right side thereof respectively, and have a negative polarity “−”, and so on. In other words, on the whole, as long as the data signals of column inversion are respectively input to the data lines D of the display panel, for example, the data signals of the positive, negative, positive, negative, positive, and negative polarity are respectively input to the data lines D1-D6, an effect of two dot inversion as shown in FIG. 2 is achieved. Furthermore, when the display panel 300 is driven, the polarity distribution of the sub-pixels 320 is cyclically repeated by one sub-pixel 320 as a unit U in the row direction X, and the polarity distribution of the sub-pixels 320 is cyclically repeated by two sub-pixels 320 as a unit U in the column direction Y.

In summary, through the layout manner that each two sub-pixels 320 in any column in the sub-pixel array 310 are electrically connected to an adjacent data line D on a different side alternately, the data lines D of the display panel 300 perform driving in a low power consumption column inversion manner, such that the sub-pixel array 310 shows a display effect of two dot inversion. Thus, when an image displayed by the sub-pixel array 310 is divided into a left-eye image I_{L} and a right-eye image I_{R} by the micro lens array, the polarity distribution of the left-eye image I_{L} and the polarity distribution of the right-eye image I_{R} may respectively show dot inversion with good display quality. Moreover, as the polarity of the 3D image at the same position after the left-eye image I_{L} and the right-eye image I_{R} are combined is the same, the problem of the flicker of the left-eye frame and the right-eye frame of the conventional 3D display 100 is solved. Therefore, the 3D display 200 of the present invention may achieve good display quality in a power-saving driving manner.

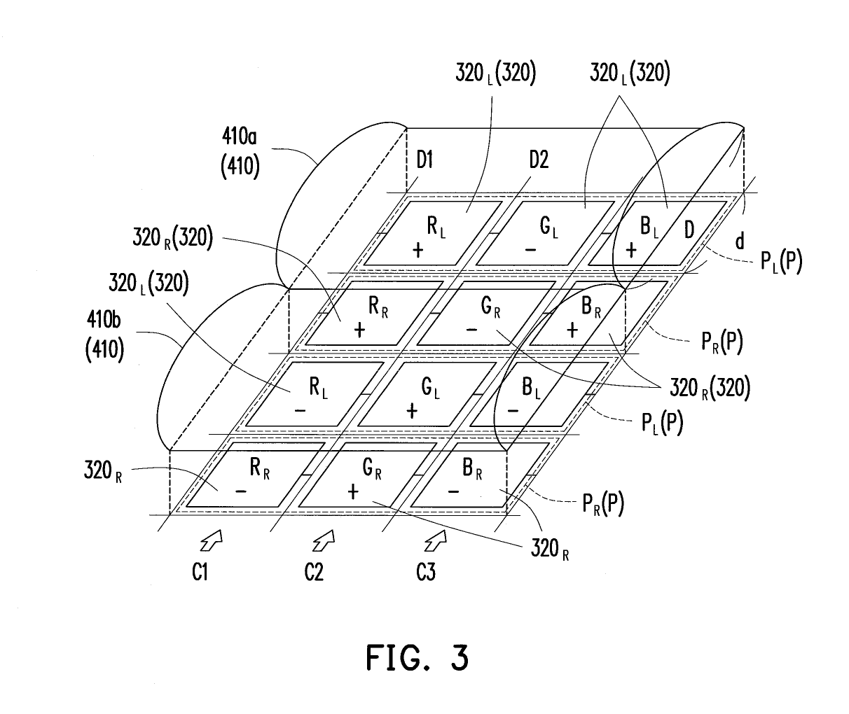

The structures of the display panel and the micro lens array in the 3D display of the present invention are further illustrated in detail with reference to FIG. 2 in combination with FIG. 3.

FIG. 3 is a schematic enlarged view of FIG. 2 captured at a site A, in which merely the part of 3×4 array sub-pixels 320 in FIG. 2 is captured as the lens unit in FIG. 3 correspondingly. Referring to FIGS. 2 and 3, the micro lens array 400 has a plurality of lens units 410. In this embodiment, each lens unit 410 of the micro lens array 400 is a lenticular lens, and thus the micro lens array 400 is formed by a plurality of lenticular lenses arranged in parallel. Each lenticular lens of the micro lens array 400 covers a plurality of sub-pixels 320, as shown in FIGS. 2 and 3, each lenticular lens of this embodiment covers two rows of sub-pixels 320, but the present invention is not limited thereto. In other embodiments, each lenticular lens is corresponding to more than two rows of sub-pixels 320.

Specifically, an extension direction of each lens unit 410 of this embodiment is, for example, parallel to the scan lines S, that is, each lens unit 410 extends in the row direction X, and the plurality of lens units 410 in the lens array are arranged in the column direction Y. As shown in FIGS. 2 and 3, any one of the lens units 410 is respectively corresponding to at least one of left-eye sub-pixels 320_{L} and at least one of right-eye sub-pixels 320_{R} at the same time. Specifically, as shown in FIG. 3, each sub-pixel 320 has a pixel pitch d parallel to the column direction Y, each lens unit 410 has a lens pitch D parallel to the column direction, and the lens pitch D of each lens unit 410 substantially satisfies the following relation formula: D=2×d. In other words, the lens pitch of each lens unit 410 is substantially twice of the pixel pitch d of each sub-pixel 320 in the direction of the data lines D. Thus, the overall resolution of the 3D display is improved.

In this embodiment, any one of the lens unit 410 is correspondingly configured on two rows of sub-pixels 320, and the two rows of sub-pixels 320 are divided into one row of left-eye sub-pixels 320_{L} used for displaying the left-eye image I_{L} and the other row of right-eye sub-pixels 320_{R} used for displaying the right-eye image I_{R}. Thus, the user can view the left-eye image I_{L} displayed by the left-eye sub-pixels 320_{L} and the right-eye image I_{R} displayed by the right-eye sub-pixels 320_{R} with the left eye and the right eye through the micro lens array 400, to combine the images into a 3D image.

Furthermore, as shown in FIG. 3, among the sub-pixels 320 in the same column, the left-eye sub-pixels 320_{L} and the right-eye sub-pixels 320_{R} corresponding to the same lens unit 410 are electrically connected to the same data line D. Taking the sub-pixels 320 in the C1 column as an example, the left-eye sub-pixels 320_{L} and the right-eye sub-pixels 320_{R} corresponding to a lens unit 410a are electrically connected to the data line D1, and the data line D1 transmits the data signals of the same polarity to the left-eye sub-pixels 320_{L} and the right-eye sub-pixels 320_{R}, such that the left-eye sub-pixels 320_{L} and the right-eye sub-pixels 320_{R} corresponding to the lens unit 410a in the C1 column have the same positive polarity “+”. Similarly, among the sub-pixels 320 in the C1 column, the left-eye sub-pixel 320_{L} and the right-eye sub-pixel 320_{R} corresponding to the lens unit 410b are electrically connected to the data line D2, and the data line D2 transmits the data signals with the same negative polarity to the left-eye sub-pixels 320_{L} and the right-eye sub-pixels 320_{R}, such that the left-eye sub-pixel 320_{L} and the right-eye sub-pixel 320_{R} corresponding to the lens unit 410b in the C1 ^{th} column have the same negative polarity “−”. Therefore, when the user views the image displayed by the sub-pixels 320 through the same lens unit 410, as the 3D image shown by the left-eye sub-pixels 320_{L} and the right-eye sub-pixels 320₈ has the same polarity at the same position, for example, in FIG. 2, the sub-pixels at the top leftmost of the left-eye image I_{L} and the sub-pixels at the top leftmost of the right-eye image I_{R} are positive polarity “+”. Therefore, the user will not feel vertigo and discomfort resulting from the flicker of the left frame and the right frame. In another aspect, as each two sub-pixels 320 in any column are electrically connected to the adjacent data line D on a different side alternately, data signals with different polarities may be transmitted to the adjacent data lines D, such that the polarity distribution of the left-eye image I_{L} and the polarity distribution of the right-eye image I_{R} will show dot inversion respectively, and thus achieving a good display quality.

In addition, in order to achieve the effect of full-color display, a pixel unit P of the display panel 300 is formed by a group of sub-pixels 320. In practice, a group of colors that are blended into white light are generally used as the colors shown by sub-pixels 320 in a group of pixel units P. Specifically, in this embodiment, the sub-pixel 320 includes a plurality of first primary color sub-pixels R showing red and arranged in the same column, a plurality of second primary color sub-pixels G showing green and arranged in the same column, and a plurality of third primary color sub-pixels B showing blue and arranged in the same column. For example, the red sub-pixels R are, for example, arranged in the first column, the fourth column, . . . , and the (3m+1)^{th} column, the green sub-pixels G are, for example, arranged in the second column, the fifth column, . . . , and the (3m+2)^{th} column, and the blue sub-pixels B are, for example, arranged in the third column, the sixth column, . . . , and the (3m+3)^{th} column, in which m is a positive integer. The first primary color sub-pixels R, the second primary color sub-pixels G, and the third primary color sub-pixels B of each row are alternately arranged in sequence, and among the sub-pixels 320 in the same row, the adjacent first primary color sub-pixel R, second primary color sub-pixel G, and third primary color sub-pixel B form one pixel unit P, for displaying a pattern with integral grey-scale and color.

Moreover, according to the above description, when the sub-pixels 320 of different primary colors are further divided into left-eye sub-pixels 320_{L} and right-eye sub-pixels 320_{R}, the left-eye sub-pixels 320_{L} and the right-eye sub-pixels 32O_{R} of the same primary color are alternately arranged in the display panel 300 in the column direction Y. For example, in the C1 column, the arrangement manner of the sub-pixels 320 from top to bottom is R_{L}R_{R}R_{L}R_{R}, in which the superscripts R, G, B represent red sub-pixels, green sub-pixels, and blue sub-pixels respectively, and the subscripts L and R represent the left-eye sub-pixels 320_{L} and the right-eye sub-pixel 320_{R} respectively; similarly, in the C2 column, the arrangement manner of the sub-pixels 320 from top to bottom is G_{L}G_{R}G_{L}G_{R}; similarly, in the C3 column, the arrangement manner of the sub-pixels 320 from top to bottom is B_{L}B_{R}B_{L}B_{R}, and in the C4 column, the arrangement manner of the sub-pixels 320 is the same as that in the C1 column, and so on.

The red sub-pixel R, the green sub-pixels G, and the blue sub-pixels B of this embodiment are electrically connected to the same scan line S, so when a turn-on voltage level V_{gh} is input to corresponding scan lines S, different data lines may write corresponding data signals to the red sub-pixels R, the green sub-pixels G, and the blue sub-pixels B, and thus, the pixel unit P formed by the red sub-pixels R, the green sub-pixels G, and the blue sub-pixels B written with the corresponding data signals can show the pattern to be displayed in time. In other words, the pixel unit P of this embodiment is formed by the red sub-pixels R, the green sub-pixels G, and the blue sub-pixels B arranged in the same row, and is electrically connected to the same scan line, thereby showing the pattern to be displayed in time. In comparison, when the pixel structure is formed by the red sub-pixels R, the green sub-pixels G, and the blue sub-pixels B arranged in the same column, as the red sub-pixels R, the green sub-pixels G, and the blue sub-pixels B are electrically connected to three different scan lines and the same data line respectively, the pixel unit P can show the pattern to be displayed integrally after the pixel unit formed by the sub-pixel configuration waits three times of the turn-on time of the scan line. Definitely, the color shown by each sub-pixel 320 in a group of sub-pixels 320 (pixel unit P) may be changed, or each sub-pixel 320 in a group of sub-pixels 320 may show combinations of other colors, for example, a combination of yellow, magenta, and cyan, and the present invention is not limited thereto.

In order to further describe the driving manner of a 3D display of the present invention clearly, taking the 3D display 200 in FIG. 2 as an example, a driving method applied to drive the display panel 300 in the 3D display 200 is exemplified.

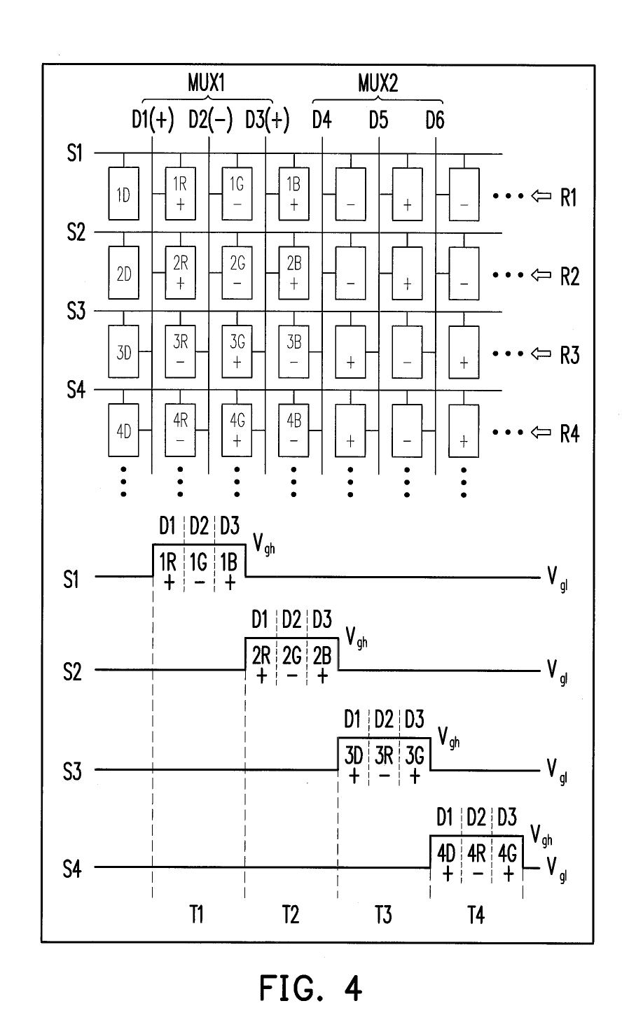

FIG. 4 shows a schematic view of a state of the display panel in the 3D display in FIG. 2 under a driving method at an upper part and a schematic view of a signal state of the display panel in the 3D display in FIG. 2 in a frame time at a lower part, that is, FIG. 4 shows a schematic view after the micro lens array in FIG. 2 is removed in the upper part and driving waveforms of the scan lines S and the data lines D in a frame time in the lower part.

For ease of illustration, in FIG. 4, the symbol “+” and the symbol “−” represent the relative polarity of the data signal, and sub-pixels 1R, 1G, and 1B represent the red sub-pixels R, the green sub-pixels G, and the blue sub-pixels B in the first row R1 respectively, and sub-pixels 2R, 2G, 2B represent the red sub-pixels R, the green sub-pixels G, and the blue sub-pixels B in the second row R2 respectively, and so on, and sub-pixels 1D-4D represent dummy sub-pixels D in the first row to the fourth row R1-R4 respectively. Additionally, the driving manner of the data line D of this embodiment is described with a 1 to 3 Mux as an example, that is, the data lines D1-D3 are electrically connected to a control signal line MUX1 together, and the control signal line MUX1 transmits different data signals to the data lines D1-D3 in turn-on time of a corresponding scan line S. Herein, in the driving waveforms in the lower part of FIG. 4, merely the driving waveforms of the data lines D1-D3 electrically connected to the same control signal line MUX1 are exemplified for illustration.

Referring to FIG. 4, the sub-pixels 1R, 1G, 1B in the same row R1 are electrically connected to the adjacent data lines D1, D2, D3 on the left side respectively. In a first time T1, a turn-on voltage level V_{gh} is applied to a scan line S1, the turn-on voltage level V_{gh} turns on the sub-pixels 1R, 1G, 1B in the row R1 and connected to the data lines D1-D3 respectively through the scan line S1, and at this time, the data lines D1-D3 transmit the data signals of positive polarity, negative polarity, and positive polarity to the correspondingly turned-on sub-pixels 1R, 1G, and 1B in the row R1 respectively, such that the sub-pixels 1R, 1G, and 1B in the row R1 show the positive polarity “+”, the negative polarity “−”, and the positive polarity “+” in the frame time respectively.

Next, in a second time T2, the sub-pixels 2R, 2G, and 2B in the same row R2 are electrically connected to the adjacent data lines D1, D2, D3 on the left side. In the second time T2, a turn-on voltage level V_{gh} is applied to a scan line S2, and a turn-off voltage level V_{gl} is applied to the other scan lines. As the turn-on voltage level V_{gh} turns on the sub-pixels 2R, 2G, and 2B in a row R2 and connected to the data lines D1, D2, and D3 through the scan line S2, at this time, the data lines D1, D2, and D3 transmit data signals of positive polarity, negative polarity, and positive polarity to the correspondingly turned-on sub-pixels 2R, 2G, and 2B in the row R2 respectively, such that the sub-pixels 2R, 2G, and 2B in the row R2 show the positive polarity “+”, the negative polarity “−”, and the positive polarity “+” in the frame time respectively.

Similarly, in a third time T3, a turn-on voltage level V_{gh} is applied to a scan line S3, and a turn-off voltage level V_{gl} is applied to the other scan lines. The turn-on voltage level V_{gh} turns on the sub-pixels 3D, 3R, and 3G in a row R3 and connected to the data lines D1-D3 through the scan line S3, and at the same time, the data lines D1-D3 similarly transmit data signals of positive polarity, negative polarity, and positive polarity to the correspondingly turned-on sub-pixels 3D, 3R, and 3G in the row R3 respectively, such that the sub-pixels 3D, 3R, and 3G in the row R3 show the positive polarity “+”, the negative polarity “−”, and the positive polarity “+” in the frame time respectively. Similarly, in a fourth time T4, a turn-on voltage level V_{gh} is applied to a scan line S4, and a turn-off voltage level V_{gl} is applied to the other scan lines, such that the data lines D1-D3 similarly transmit data signals of positive polarity, negative polarity, positive polarity to the correspondingly turned-on sub-pixels 4D, 4R, and 4G in the row R4 respectively, such that the sub-pixels 4D, 4R, and 4G in the row R4 show the positive polarity “+”, the negative polarity “−”, and the positive polarity “+” in the frame time respectively, and the action principle is similar to that described above and will not be repeated therein.

It should be noted that, it can be known from the driving mechanism described above that, as for the same data lines D1, D2, and D3, in the same frame time, the polarity of the data voltage transmitted by each of the data lines D1, D2, and D3 remains unchanged. For example, in the previous embodiments, the odd-number data lines, such as data lines D1 and D3, transmit data voltages of the same positive polarity but different levels (or same level) to corresponding sub-pixels in the left and right columns in a frame time in which different scan lines S1-S4 are turned on, till all the scan lines S on the display panel have been turned on for one round sequentially; the even-number data lines, such as the data line D2, transmit the data voltages of the same negative polarity but different levels to the corresponding sub-pixels in the left and right columns in a frame time in which different scan lines S1-S4 are turned on, till all the scan lines S on the display panel have been turned on for one round sequentially. In a next frame time, the data voltages transmitted by the odd-number data lines, such as the data lines D1 and D3, are converted from the positive polarity to the negative polarity, and the data voltages transmitted by the even-number data lines, such as the data line D2, are converted from the negative polarity to the positive polarity.

In conclusion, the turn-on voltage level V_{gh} is input to the scan lines S1-S4 in the 3D display 200 of the present invention one by one according to a timing control, so as to turn on the sub-pixels in different rows corresponding to the scan lines S sequentially. Next, in a frame time, a first polarity signal is input to the odd-number data lines D, and a second polarity signal different from the first polarity signal is input to the even-number data lines D. As for the previous example, in a frame time, the first polarity signal input to the odd-number data lines D is an inverse polarity signal of the positive polarity “+”, while the second polarity signal input to the even-number data lines D is, for example, an anti-inverse polarity signal of the negative polarity “−”, and thus the display effect of two dot inversion is shown as shown in the upper part of FIG. 4 in a frame time. In a next frame time, the second polarity signal input to the odd-number data lines D is, for example, an anti-inverse polarity signal of the negative polarity “−”, while the first polarity signal input to the even-number data lines D is an inverse polarity signal of the positive polarity “+”.

Therefore, in the 3D display of the present invention, the display panel can achieve the display effect of two dot inversion with a simple and power-saving column inversion driving method through the suitable layout manner of the data lines and the sub-pixels. Thus, after an image displayed by the display panel of this embodiment passes through the micro lens array, the produced left-eye image I_{L} and right-eye image I_{R} will show the display effect of dot inversion respectively. Furthermore, as the polarity distribution of the left-eye image I_{L} and the polarity distribution of the right-eye image I_{R} have the same polarity at the same position in the 3D image (as shown in FIG. 2), the problem of flicker of the frames of the 3D image may be eliminated. Thus, vertigo and discomfort caused by the inversion of the left-eye signal and the right-eye signal is eliminated significantly.

Additionally, through the suitable layout of the data lines and the sub-pixels, the corresponding data voltages (or signals) are respectively input to the corresponding sub-pixels through timing control, such that the data lines are driven in a manner of low-power consumption line conversion, such as a column inversion manner, so as to achieve the display effect of two dot inversion of the sub-pixels. Thus, in such layout manner, the polarity change of each data line is reduced, thereby reducing the energy consumption of a data driver chip, so as to achieve the purpose of power saving and cost reducing. In other words, in the 3D display and the driving method thereof of the present invention, the left-eye image I_{L} and the right-eye image I_{R} for forming a 3D image respectively achieve the display effect of dot inversion in a simple and power-saving driving manner, such as column inversion, thereby improving the display quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three-dimensional (3D) display, comprising:
a display panel, comprising:
a plurality of scan lines;
a plurality of data lines, intersecting the scan lines;
a sub-pixel array, comprising a plurality of sub-pixels arranged in an array, wherein sub-pixels arranged in any row are electrically connected to the same scan line, each two sub-pixels in any column are electrically connected to an adjacent data line on a different side alternately, polarity distribution of the sub-pixels is cyclically repeated in a row direction by one sub-pixel, and polarity distribution of the sub-pixels is cyclically repeated in a column direction by two sub-pixels; and
a micro lens array, comprising a plurality of lens units, wherein an image displayed by the display panel produces a left-eye image and a right-eye image after passing through the micro lens array.

2. The 3D display according to claim 1, wherein the sub-pixels comprise a plurality of left-eye sub-pixels for displaying the left-eye image and a plurality of right-eye sub-pixels for displaying the right-eye image.

3. The 3D display according to claim 2, wherein the left-eye sub-pixels are arranged in odd-number rows, and the right-eye sub-pixels are arranged in even-number rows.

4. The 3D display according to claim 2, wherein any one of the lens units is corresponding to at least one of the left-eye sub-pixels and at least one of the right-eye sub-pixels simultaneously, and among the sub-pixels in the same column, the left-eye sub-pixel and the right-eye sub-pixel corresponding to the same lens unit are electrically connected to the same data line.

5. The 3D display according to claim 1, wherein each lens unit extends in the row direction, each sub-pixel comprises a pixel pitch d parallel to the column direction, each lens unit comprises a lens pitch D parallel to the column direction, and the lens pitch D of each lens unit substantially satisfies the following relation formula: D=2×d.

6. The 3D display according to claim 1, wherein the sub-pixels arranged in a (4n+1)^{th} row and a (4n+2)^{th} row are electrically connected to an adjacent data line on a left side thereof respectively, the sub-pixels arranged in a (4n+3)^{th} row and a (4n+4)^{th} row are electrically connected to an adjacent data line on a right side thereof respectively, and n is a positive integer.

7. The 3D display according to claim 1, wherein the sub-pixels comprise a plurality of first primary color sub-pixels arranged in the same column, a plurality of second primary color sub-pixels arranged in the same column, and a plurality of third primary color sub-pixels arranged in the same column, the first primary color sub-pixels, the second primary color sub-pixels, and the third primary color sub-pixels of each row are alternately arranged in sequence.

8. The 3D display according to claim 7, wherein among the sub-pixels in the same row, the adjacent first primary color sub-pixel, second primary color sub-pixel, and third primary color sub-pixel constitute a pixel unit.

9. The 3D display according to claim 1, wherein a polarity of a data voltage respectively transmitted by each data line remains unchanged in the same frame time.

10. The 3D display according to claim 1, wherein the sub-pixel array further comprises a plurality of dummy sub-pixels, configured on at least one side of the sub-pixels, and electrically connected to at least one data line on an outermost side.

11. A driving method of a three-dimensional (3D) display, applied to drive the 3D display according to claim 1, the method comprising:
turning on the scan lines sequentially; and
in a frame time, inputting a first polarity signal to odd-number data lines, and inputting a second polarity signal to even-number data lines.

12. The driving method of a 3D display according to claim 11, further comprising in a next frame time, inputting the second polarity signal to the odd-number data lines, and inputting the first polarity signal to the even-number data lines.

13. The driving method of a 3D display according to claim 11, wherein an inverse polarity signal is input to the odd-number data lines, and an anti-inverse polarity signal is input to the even-number data lines, such that display of the sub-pixel array is shown in a manner of two dot inversion.
